(19) United States
(12) Patent Application Publication
(10) Pub. No.: US 2011/0272898 A1
(43) Pub. Date: Nov. 10, 2011

(54) Clamping device

(76) Inventor: Karl Hiestand, Pfullendorf (DE)

(21) Appl. No.: 13/068,177

(22) Filed: May 4, 2011

(30) Foreign Application Priority Data
May 4, 2010 (EP) 10161837.9

(51) Int. Cl. B23B 31/26; B23Q 17/00; B23B 31/36

(52) U.S. Cl. 279/126; 279/134; 173/176

(57) ABSTRACT

A clamping device for machine tools is provided with a chuck, the clamping jaws of which are actuated by a draw rod, the clamping device having of a servomotor, a movement converter and a force accumulator, the servomotor is connectable to the movement converter for triggering clamping movements. The movement converter and the force accumulator are disposed in a housing connectable to the machine spindle, and in clamping position of the clamping device, the sliding sleeve can be decoupled from the servomotor, and the housing can be connected to the movement converter by means of the sliding sleeve.

The servomotor is operated only to clamp and unclamp a workpiece, and is in a driving connection with the clamping device in operating conditions. All components of the clamping device involved in power transmission are in driving connection with the machine spindle during the machining of the workpiece.

### BACKGROUND OF THE INVENTION

1. Field of the Invention

The present invention relates to a clamping device for machine tools, and that provided with a power-operated chuck for holding a workpiece, for example, and clamping jaws which can be actuated using the clamping device by means of an axially moveable draw rod, in which the clamping device includes an electric servomotor with a changeover function for triggering clamping movements, a movement converter for converting the adjustment movements of the rotor shaft of the servomotor into axial movements of the draw rod required for actuating the clamping jaws, and a force accumulator for maintaining the clamping force, as well as a process for controlling the servomotor according to the rotation speed of the drive motor of the machine tool.

2. Description of the Prior Art

A clamping device of this kind is disclosed in EP 0 228 007 A2. In this embodiment, as soon as electrical energy is applied to the servomotor, the rotor of the servomotor is pushed axially against the force of a spring into a centre position by means of the electromagnetic force established between the stator and rotor, and is connected to the draw rod by the movement converter which is formed by intermeshing threads. In addition, this component activates the force accumulator comprising several cup spring packs as soon as the draw rod is no longer moved.

Although the complexity of the design is therefore considerable, the power-operated chuck is not secured during a machining process. The components involved in force transmission are not intrinsically supported against turning back, therefore the chuck can open spontaneously. The clamping device of prior art can therefore not be used in practice.

### SUMMARY OF THE INVENTION

The object of the present invention is, therefore, to provide a clamping device of the aforementioned type wherein the servomotor only has to be taken into operation in order to clamp and to unclamp a workpiece, and is therefore only in a driving connection with the clamping device in these operating conditions. Above all, however, during machining of a workpiece, all the components of the clamping device involved in the force transmission are in a firm driving connection with the machine spindle, with the effect that return movements of the power-operated chuck are excluded. In addition, the power-operated chuck makes it possible to achieve a defined re-clamping. Accordingly, a reliable operating method of the clamping device is guaranteed at all times.

In accordance with the present invention, this is achieved in a clamping device of the aforementioned type wherein the servomotor for triggering clamping movements can be connected directly to the movement converter via a controllably adjustable sliding sleeve or by means of intermediate elements, wherein the movement converter and the force accumulator are inserted in a housing that can be connected to the machine spindle of the machine tool and wherein in the clamping position of the clamping device, the sliding sleeve can be decoupled from the servomotor and the housing can be firmly connected to the movement converter via the sliding sleeve.

In this case, it is advantageous for the housing of the clamping device to be configured with a Z-shaped cross section which consists of a sleeve facing towards the machine spindle for holding the movement converter, and of the force accumulator, and of a hollow shaft facing the servomotor for holding the sliding sleeve, in which case the sleeve and the hollow shaft of the housing are connected together firmly by means of an intermediate wall.

Furthermore, one or more intermediate elements are mounted in a rotating arrangement in the intermediate wall of the housing to provide the shape-locking driving connection of the sliding sleeve with the movement converter, in which case each of the intermediate elements consists of a shaft provided with differently designed gears, which are connected on the one hand to the sliding sleeve either directly or via intermediate gears, and on the other hand with the movement converter, and are configured as a step-down gearbox.

In accordance with a different embodiment, the housing can be configured in the shape of a pot with an axially projecting sleeve formed onto a plate-shaped ring that is connected to the machine spindle with a radial gap from the draw rod, with the movement converter and the force accumulator to be inserted into the sleeve.

Furthermore, it should be possible to connect the sliding sleeve to a drive gear connected to the servomotor and to the housing, or its intermediate wall, by means of two sprocket wheels, each arranged on the lateral end surfaces via sprocket wheels attached to the intermediate wall, in an alternating form-locking arrangement. The teeth on the sprocket wheels fit in the drive gear, the housing and the sliding sleeve are arranged and spaced apart from one another, such that when there is an adjustment movement of the sliding sleeve, the intermeshing teeth overlap until the corresponding limit position of the sliding sleeve is adopted. Furthermore, the sliding sleeve supported against the force of one or more compression springs on a flange attached to the hollow shaft of the housing.

It is also advantageous for the sliding sleeve to be moved axially by means of a servo device, for example in the form of an adjusting piston inserted in a cylinder and adjustable by means of a pressurised medium, or by an electromagnet.

The servomotor that can be connected to the drive gear directly, or via intermediate elements, can be arranged flush, axially in parallel or axially at right angles to the lengthways axis of the housing of the clamping device.

In a simple embodiment, the movement converter is formed by a planetary roller arranged between a hollow shaft that can be connected to the servomotor and the draw rod, in which case the force accumulator can be arranged on the hollow shaft of the movement converter and be activated by the hollow shaft.

The force accumulator consists of a spring pack inserted between two roller bearings with a constant spacing and clamped against one another, and two sleeves provided at the side next to the spring pack and which extend over the roller bearings, with the spring pack making contact with the end faces of the sleeves that face towards one another. In order to activate the force accumulator, it is appropriate for stops provided on the housing to be allocated to the sleeves, with the outer end surfaces of the sleeves interacting alternately with the stops.

In this case, the spring pack consists of several coil pressure springs inserted between the two roller bearings, or spacer pins supported on the outer races and lined up in an even distribution around the circumference, or coil pressure springs arranged next to the spacer pins, in which case the coil pressure springs preferably have a rectangular cross section or are formed from cup springs.

By clamping the force accumulator with the supported draw rod, it is possible to adjust the hollow shaft of the movement converter in each case opposite to the adjustment direction of the draw rod, through an adjustment distance that, in a preferred embodiment, can be selected in both adjustment directions.

In accordance with a further embodiment, there is provision for the clamping device to be provided with a distance measuring device which can consist of a position indicator arranged directly on the draw rod, or attached to it by means of intermediate elements, for example, in the form of a sensor ring, and of a sensor arranged in a fixed location, the signals from which can be sent to a display unit, in which case the position indicator of the distance measuring device passes through the housing of the clamping device and the sensor is supported on the machine tool at the height of the position indicator.

Furthermore, it is appropriate for the drive motor of the machine tool to be electrically connected to the servomotor by means of a control unit. This makes it possible to control the servomotor of the clamping device, depending on the rotation speed of the drive motor of the machine tool, in such a way that the rotation speed of the servomotor for increasing or reducing the clamping force of the power-operated chuck during the machining process can be adjusted by means of the control unit so that the servomotor rotates synchronously with the rotation speed of the drive motor for coupling the drive gear with the sliding sleeve, and the servomotor can be driven with increased or reduced speed in relation to the synchronous speed in order to increase or reduce the clamping force.

If a clamping device is configured in accordance with the present invention, it precludes any uncontrolled change in the clamping force of the power-operated chuck during a working procedure, and precludes the power-operated chuck from coming open spontaneously. Due to the fact that the servomotor is only in a driving connection with the components involved in power transmission for clamping and releasing a workpiece, the components can only trigger adjusting movements under these operating conditions. During a working procedure, however, the components involved in power transmissions are connected to the machine spindle via the sliding sleeve, and are therefore blocked. A change in position of the draw rod, and therefore unclamping in the power-operated chuck, is therefore impossible.

On the other hand, the power-operated chuck does guarantee that the clamping force is maintained, even when there is a reduction due to the machining of the workpiece. This is because the movement converter enables the force accumulator to be pre-loaded in a defined manner. As a result, the energy stored in the accumulator is available for re-clamping procedures.

As a result, and with a low design complexity, a clamping device is provided which not only has a relatively straightforward design structure, thereby allowing it to be manufactured economically, but also, and above all, guarantees reliable operation at all times with a low energy consumption, because the servomotor can be taken out of operation during machining, and has a wide range of uses.

### BRIEF DESCRIPTION OF THE DRAWINGS

The drawings show a sample embodiment and variants of the clamping device configured in accordance with the present invention, the details of which are explained below. In the drawings,

FIG. 1 shows the clamping device in an axial section during a machining procedure,

FIG. 2 shows the clamping device in accordance with FIG. 1 in a half-section and magnified view, with a connected servomotor,

FIG. 3 shows the clamping device in accordance with FIG. 1 in a half-section and magnified presentation,

FIG. 4 is a section from FIG. 3 in a magnified presentation, and

FIG. 5 shows a configuration variant of the clamping device in accordance with FIG. 1, mounted on the machine spindle of a machine tool, in a representation according to FIG. 3.

### DESCRIPTION OF THE PREFERRED EMBODIMENTS

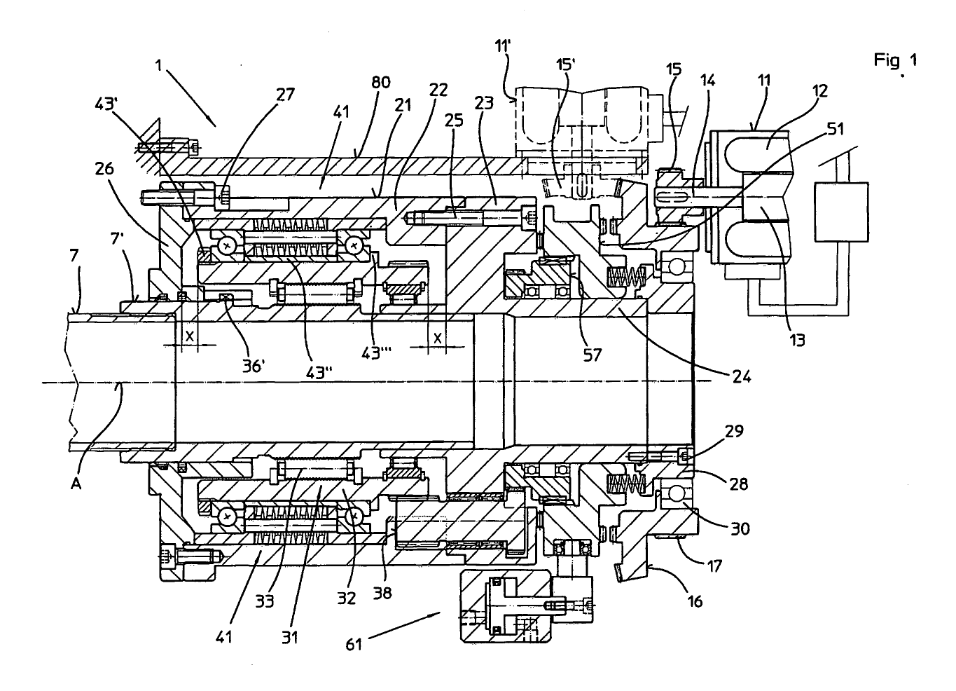

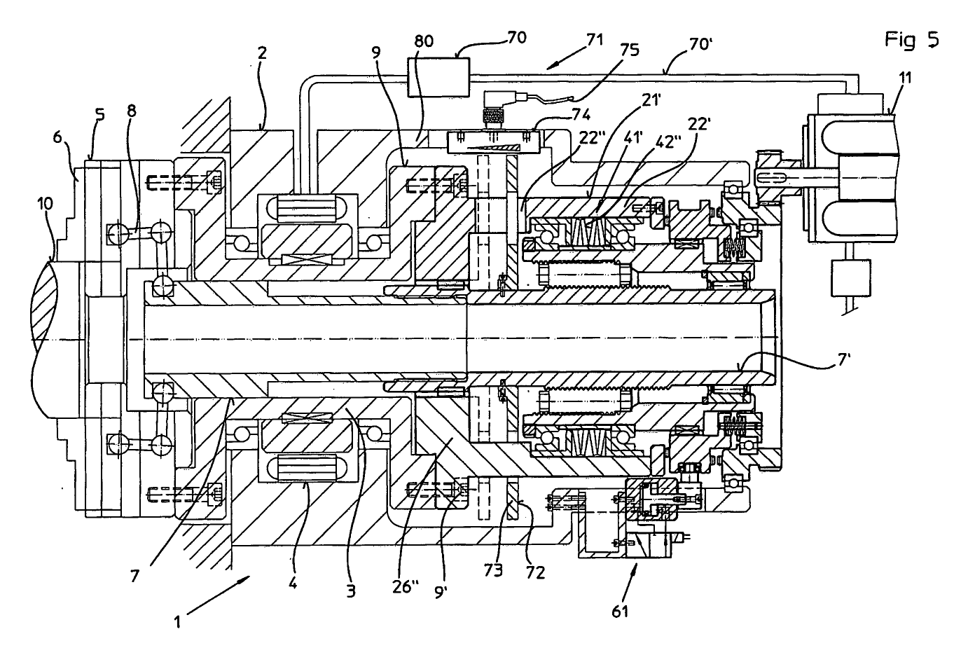

The clamping device illustrated in FIGS. 1 and 5 and identified by 1, is used for actuating a power-operated chuck 5 (FIG. 5) arranged on a machine tool 2, by means of radially adjustable clamping jaws 6 by which a workpiece 10 to be machined can be clamped in the chuck 5. The clamping jaws of the power-operated chuck 5 in this case can be actuated via relay levers 8 by an axially adjustable, two-piece draw rod 7, 7′ that is in driving connection with an electric servomotor 11 that has a changeover function by means of a movement converter 31 or 31′. The movement converter 31 or 31′ converts rotational movements of the servomotor 11 into axial feed movements of the draw rod 7, 7′.

The servomotor 11 consists of a stator 12 in a fixed location located with its axis in parallel to the lengthways axis A of the clamping device 1, and of a rotor 13 with a pinion 15 connected in a rotationally fixed arrangement with a rotor shaft 14 of the rotor 13, which engages in gearing 17 attached to a drive gear 16. However, as shown in dashed lines in FIG. 1, the servomotor 11′ can also be arranged axially perpendicular to the lengthways axis A and engage by means of a pinion 15′ in the drive gear 16 which carries gearing 19 that is assigned to this pinion 15′.

The movement converter 31 in the embodiment of the clamping device 1 shown in FIG. 1, is inserted in a Z-shaped housing 21 which, as can be seen in FIG. 5, is fastened by means of bolts 9′ to a flange 9 of a machine spindle 3 driven by an electric motor 4. The housing 21 in this case has a sleeve 22, an intermediate wall 23 connected to the sleeve 22 by means of bolts 25, as well as a hollow shaft 24 mounted on the intermediate wall 23. A cover 26 closes the sleeve 22 on the side facing the machine spindle 3. On the opposite side, however, a flange 28 is attached to the hollow shaft 24 by means of bolts 29, and the drive gear 16 is mounted in a rotating arrangement on the hollow shaft 24 by means of a bearing 30. The cover 26 is firmly connected to the sleeve 22 by means of bolts 26′. Bolts 27, which pass through the cover 26, attach the sleeve 22, and therefore the housing 21, to the machine spindle 3.

In the embodiment shown in FIG. 5, however, the housing 21′ has a pot-shaped cross section. In this case, an axially projecting sleeve 22′ is formed on a plate-shaped ring 26″ with a radial distance from the draw rod 7′, with the movement converter 31′ and the force accumulator 41′ inserted into the sleeve 22′.

The movement converter 31 or 31′ consists of a hollow shaft 32 in a driving connection with the servomotor 11 and of planetary rollers 33 which are inserted between the hollow shaft 32 and the draw rod 7 and engage in a male thread 35 worked into the draw rod 7 by means of a thread 34. A bearing 36 and a shoulder 36′ supported in the cover 26 hold the hollow shaft 32 in a rotationally fixed arrangement.

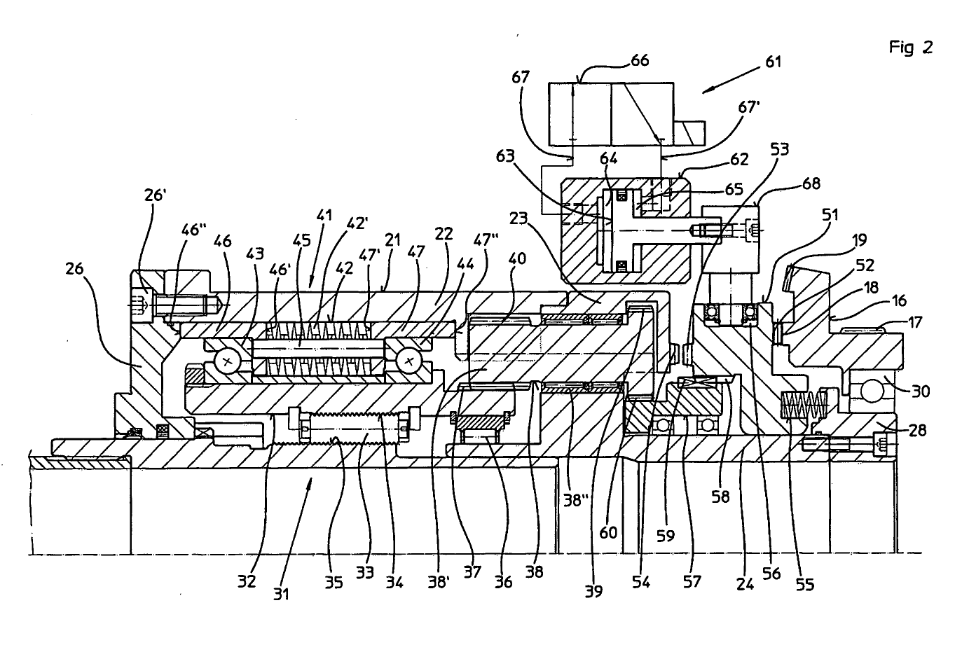

The driving connection between the drive gear 16 assigned to the servomotor 11 and the hollow shaft 32 of the movement converter 31 is achieved by means of the sliding sleeve 51. In the operating status shown in FIG. 2, in which a clamping procedure is performed, the drive energy is transmitted from the drive gear 16 via a sprocket wheel 18 attached to the drive gear 16 and via a sprocket wheel 52 provided on the sliding sleeve 51, and onto the sliding sleeve 51. Internal gearing 58 drives an intermediate gear 57 via the sliding sleeve 51, in which case the intermediate gear 57 is in a driving connection the sliding sleeve 51 by means of external gearing 59. The intermediate gear 57 is in a driving connection with a gear 39 via another external gearing 60, and the gear 39 is worked as an intermediate element 38 onto a shaft 38′ in a rotating mounting in the intermediate wall 23 by means of a roller bearing 38″. The driving connection is provided by means of more gearing 40 attached to the shaft 38′, which engages in a gear 37 provided on the hollow sleeve 22.

In the embodiment shown in FIG. 5, the sliding sleeve 41 is in a direct driving connection with the hollow shaft 32 of the movement converter 31.

The force accumulator 41′ has a spring pack 42 inserted between two roller bearings 43 and 44 arranged at a constant distance from one another, as well as two sleeves 46 and 47 with an angled configuration. The spring pack 42 is provided as a plurality of coil pressure springs 42′ or cup springs 42″ (FIG. 5) distributed evenly around the circumference, disposed between the sleeves 46 and 47 and held on spacer pins 45, which are supported against end faces 46′ and 47′ of the sleeves 46 and 47 which face one another. The outer end faces 46″ and 47″ of the sleeves 46 and 47, on the other hand, interact with stops 48 and 49 provided on the housing 21. The inner races of the roller bearings 43 and 44 are clamped against one another in this case by means of a nut 43′ screwed onto the hollow shaft 32, a sleeve 43″ disposed between the roller bearings 43 and 44, as well as a shoulder 43′″ projecting from the hollow shaft 32.

The sliding sleeve 51 is actuated by a servo device 61 consisting of a piston 63 disposed in a cylinder 62 which can be pressured on both sides by a pressurised medium. The piston 63 is in a-driving connection with the sliding sleeve 51 by means of an angle piece 68 which engages in the circumferential groove 56 in the sliding sleeve 51.

If a pressurised medium is supplied to the pressure chambers 64 or 65 of the servo device via a valve 66 and pressure lines 67 or 67′, then the piston and, with it, the angle piece 68 is pushed to the right or to the left. The sliding sleeve 51 is entrained by the angle piece 68, with the effect that the sliding sleeve 51 is also moved to the right or left sprocket wheels 52 or 53 provided on the end faces of the sliding sleeve 51 engage alternately in the sprocket wheel 18 attached to the drive gear, or a sprocket wheel 54 on the intermediate piece 23 or the sleeve 22′. The sprocket wheels 18, 52, 53 and 54 on the drive gear 16 of the sliding sleeve 51 and the housing 21 should be spaced apart from one another in such a way that when the sliding sleeve 41 performs an adjusting movement, the intermeshing gearings overlap one another until the limit position of the sliding sleeve 41 is, reached. In order for the driving connection between the sliding sleeve 51 and the housing 21 to be secured when the gearings of the sprocket wheels 53 and 54 are engaged, the sliding sleeve 51 is supported on the flange 28 by means of a compression spring 55.

In order to clamp a workpiece 10 in the power-operated chuck 5, the sliding sleeve 51 has to be moved out of the position shown in the clamping device 1 in FIG. 1 and to the right by actuation of the servo device 61, with the effect that the sprocket wheel 52 attached to the sliding sleeve 51 engages in the sprocket wheel 18 provided on the drive gear 16, as shown in FIG. 2. If, in this operating condition, the servomotor 11 is switched on, then the torque output from the motor is transmitted via the sliding sleeve 51, the intermediate gear 57, as well as the intermediate element 38, and onto the hollow shaft 32 of the movement converter 31. The threaded roller spindle 33 converts the initiated rotational movement into a translational movement and the draw rod 7 is pushed to the left or the right, depending on the direction of rotation initiated, with the effect that the clamping jaws 6 of the power-operated chuck 5 are pressed against the workpiece 10 from the inside or the outside.

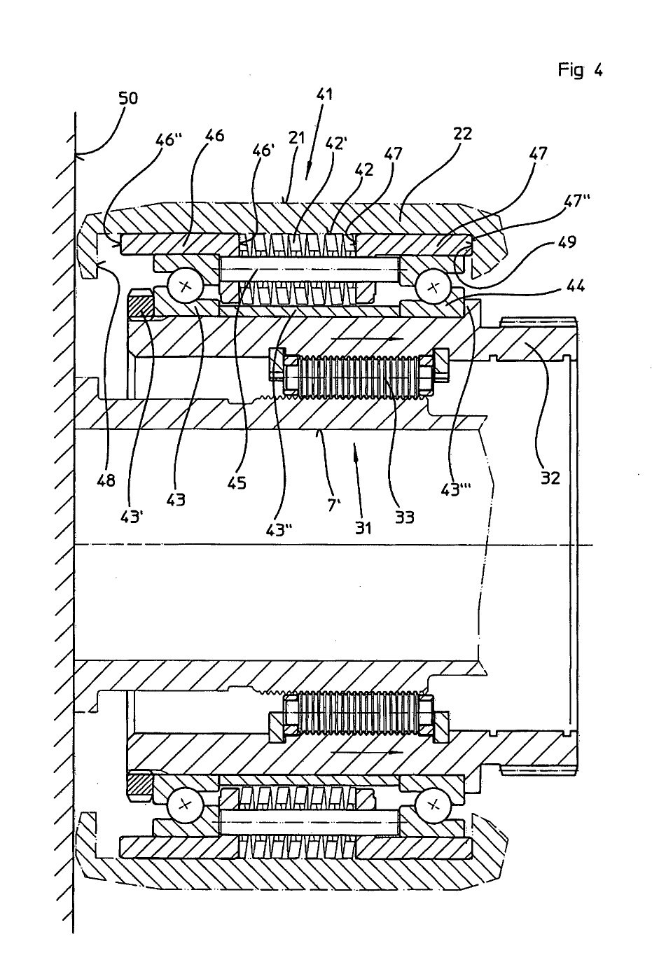

The force accumulator 41′ is activated as soon as a selectable clamping force has been achieved. The clamping jaws 6 in contact with the workpiece 10 form a kind of stop in this operating condition, as shown schematically in FIG. 4, with the effect that the draw rod 7 is stopped. In this operating condition, if the torque initiated by the servomotor 11 is continued, the threaded roller spindle 33 reverses the movement direction and the hollow shaft 32 is moved to the right (assuming that the draw rod 7 was initially moved to the left), and this movement takes place over a selectable adjustment travel X until an end face 47″ of the sleeve 47 makes contact with the stop 49 on the housing 21, as shown in FIG. 4. As soon as work-related changes on the workpiece 10 mean that the clamping force is reduced, the force accumulator 41′ can output the energy stored in the spring pack 42, with the effect that a loss is in clamping force is compensated automatically.

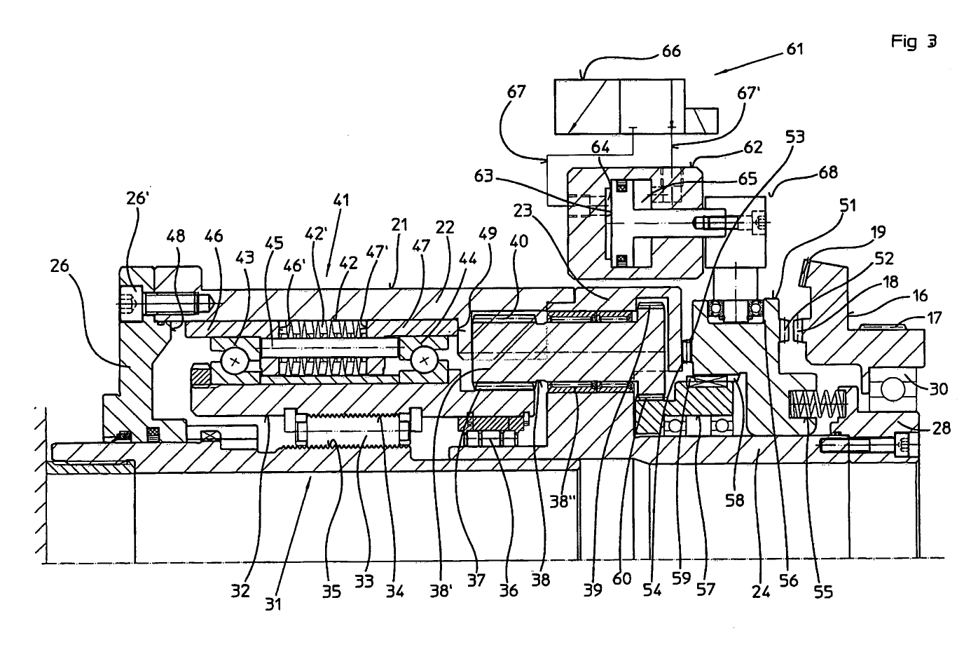

After the workpiece 10 has been clamped, the servomotor 11 can be disconnected from the movement converter 31. To do this, the sliding sleeve 51 has to be moved into the position shown in FIG. 3 with the help of the servo device 61. The teeth of the sprocket wheel 53 engage in the teeth of the sprocket wheel 54, which is attached to the housing 21. In addition, the sliding sleeve 51 is in a driving connection with the hollow shaft 32 of the movement converter 31 by means of the intermediate gear 57 and the intermediate gear 58.

The housing 21 is connected to the machine spindle 3 of the machine tool 2, therefore the components of the clamping device 1 or 1′ that are involved in the force transmission—with the exception of the decoupled drive gear 16—are blocked and rotate together with the machine spindle 3. Spontaneous opening of the power-operated chuck 5 is therefore excluded, with the effect that a high level of operational safety is guaranteed.

To preclude the possibility of the movement converter 31 being secured, either by the servomotor 11 or by the machine spindle 3, during a switching procedure, the interacting gearings of the drive gear 16, the housing 21, and the sliding sleeve 51 are arranged in such a way that during an adjusting movement of the sliding sleeve 51, the intermeshing gearings overlap until the particular limit position of the sliding sleeve 51 is reached. This means support for the movement converter 31 is provided at all times.

Also, in order to increase or reduce the clamping force of the power-operated chuck 5 with the help of the servomotor 11 during a machining procedure, as shown in FIG. 5, the drive motor 4 of the machine tool 2 is electrically connected to the servomotor 11 via a control unit 70 and connecting lines 70′. Depending on the speed of the drive motor 4, the control unit 70 can be used to set the rotation speed of the servomotor 11 in such a way that it rotates synchronously with the rotation speed of the drive motor 4 prior to the connection between the drive gear 16 and the sliding sleeve 51. If the rotation speed of the servomotor 11 is increased or reduced compared to the rotation speed of the drive motor 4, then the clamping force of the power-operated chuck 5 is increased or reduced.

In order to allow the operating condition of the power-operated, chuck 5 to be monitored during working procedures, the clamping device 1 is equipped with a position measuring device 71, as shown in FIG. 5. In this case, a position indicator 72, in the form of a sensor ring 73, is attached directly to the draw rod 7′, and the sensor ring 73 passes through the housing 21′, which is provided with a corresponding opening 22″, and activates a sensor 74 located on a wall 80 in a fixed location. The signals which are picked up depending on the corresponding position of the draw rod 7′ and, correspondingly also on the clamping jaws 6 of the power-operated chuck 5, are sent to a control and/or display unit via a signal cable 75, and are evaluated accordingly.

1. A clamping device (1) for machine tools (2), the clamping device comprising a power-operated chuck (5) for holding a workpiece (10), and clamping jaws (6) which can be actuated by means of an axially moveable draw rod (7, 7′), the clamping device further comprising an electric servomotor (11) having a changeover function for triggering clamping movements, a movement converter (31) for converting adjustment movements of a rotor shaft (14) of the servomotor (11) into the axial movements of the draw rod (7, 7′) for actuating the clamping jaws (6), and a force accumulator (41) for maintaining clamping force,
wherein,
the servomotor (11) for triggering clamping movements is connectable directly to the movement converter (31) via a selected one of controllably adjustable sliding sleeve (51) and intermediate elements (38), wherein the movement converter (31) and the force accumulator (41) are disposed in a housing (21) connectable to a machine spindle (3) of the machine tool (2) and wherein, in the clamping position of the clamping device (1), the sliding sleeve (51) is decoupled from the servomotor (11), and the housing (21) can be connected to the movement converter (31) via the sliding sleeve (51).

2. The clamping device in accordance with claim 1,
wherein
the housing (21) of the clamping device (1) is configured with a Z-shaped cross section and comprises a sleeve (22) facing towards the machine spindle (5) for holding the movement converter (31) and the force accumulator (41), and a hollow shaft (24) facing the servomotor (11), for holding the sliding sleeve (51), and the sleeve (22) and the hollow shaft (24) of the housing (21) are connected together by means of an intermediate wall (23).

3. The clamping device in accordance with claim 2,
wherein
the housing (21) is divided between the sleeve (22) or the hollow shaft (24) and the intermediate wall (23).

4. The clamping device in accordance with claim 1,
wherein
one or more of the intermediate elements (38) are mounted in a rotating arrangement in the intermediate wall (23) of the housing (21) to provide a form-locking driving connection of the sliding sleeve (51) with the movement converter (31).

5. The clamping device in accordance claim 4,
wherein
each of the intermediate elements (38) comprises a shaft (38′) provided with gears (39, 40), which are connected on the one hand to the sliding sleeve (51), either directly or via an intermediate gear (57), and on the other hand with the movement converter (31), and are configured as a step-down gearbox.

6. The clamping device in accordance with claim 1,
wherein
the cross section of a housing (21′) is configured in the shape of a pot with an axially projecting sleeve (22′) formed onto a plate-shaped ring (26′) that can be connected to the machine spindle (3) with a radial gap from the draw rod (7′), with a movement converter and a force accumulator inserted into the sleeve (22′).

7. The clamping device in accordance with claim 1,
wherein
the sliding sleeve (51) in connectable to a drive gear (16) connected to the servomotor (11) and to the housing or the intermediate wall (23) by means of two sprocket wheels (52, 53), each arranged on lateral end surfaces via sprocket wheels (18, 54) attached to the intermediate wall (23), in an alternating form-locking arrangement.

8. The clamping device in accordance with claim 7,
wherein
teeth on the sprocket wheels (18, 54, 52, 53) fitted in the drive gear (16), the housing and the sliding sleeve (51) are spaced apart from one another, such that when there is an adjustment movement of the sliding sleeve (51), intermeshing teeth overlap until a corresponding limit position of the sliding sleeve (51) is established.

9. The clamping device in accordance with claim 1,
wherein
the sliding sleeve (51) is supported against the force of one or more compression springs (55) on a flange (28) attached to the hollow shaft (24) of the housing (21).

10. The clamping device in accordance with claim 1,
wherein
the sliding sleeve (51) is moved axially by means of a servo device (61), in the form of an adjusting piston (63) disposed in a cylinder (62) and adjustable by means of a selected one of a pressurised medium, and an electromagnet.

11. The clamping device in accordance with claim 7,
wherein
the servomotor (11, 11′) is connected to the drive gear (16) directly, or via intermediate elements, arranged flush, axially in parallel, or axially at right angles to a lengthways axis (A) of the housing (21) of the clamping device (1).

12. The clamping device in accordance with claim 6,
wherein
the movement converter (31) is formed by a planetary roller (33) arranged between a hollow shaft (32) that can be connected to the servomotor (11) and the draw rod (7′).

13. The clamping device in accordance with claim 12,
wherein
the force accumulator (41) is arranged on the hollow shaft (32) of the movement converter (31) and can be activated by the hollow shaft (32).

14. The clamping device in accordance claim 13,
wherein
the force accumulator (41) comprises a spring pack (42) inserted between two roller bearings (43, 44) with a constant spacing and clamped against one another, and two sleeves (46, 47) provided at a side next to the spring pack (42) and which extend over the roller bearings (43, 44), with the spring pack (42) making contact with end faces (46′, 47′) of the sleeves (46, 47) that face towards one another, and in order to activate the force accumulator (41), stops (48, 49) provided on the housing (21) are allocated to the sleeves (46, 47), with outer end surfaces (46″, 47″) of the sleeves (46, 47) interacting alternately with stops (48, 49).

15. The clamping device in accordance with claim 14,
wherein
the spring pack (42) comprises a selected one of coil pressure springs (42′) inserted between the two roller bearings (43, 44) and spacer pins (45) supported on the outer races and lined up in an even distribution around the circumference, the coil pressure springs (42′) arranged next to the spacer pins (45), the coil pressure springs (42′) having a rectangular cross section or comprise cup springs (42″).

16. The clamping device in accordance with claim 14,
wherein
by clamping the force accumulator (41) with the supported draw rod (7, 7′), the hollow shaft (32) of the movement converter (31) can be adjusted opposite to the adjustment direction of the draw rod (7, 7′), through an adjustment distance (x) that can be selected in both adjustment directions.

17. The clamping device in accordance with claim 1,
wherein
the clamping device (1) is provided with a distance measuring device (71).

18. The clamping device in accordance with claim 17,
wherein
the distance measuring device (71) comprises a position indicator (72) arranged on the draw rod (7′), or attached to it by means of a selected one of a sensor ring (73), and a sensor (74), signals from which are transmittable by a display unit.

19. The clamping device in accordance with claim 18,
wherein
the position indicator (72) of the distance measuring device (71) passes through the housing (21) of the clamping device (1), and the sensor (74) is supported on the machine tool (2) at the height of the position indicator (72).

20. The clamping device in accordance with claim 1,
wherein
a drive motor (4) of the machine tool (2) is electrically connected to said servomotor (11) by a control unit (70).

21. A process for controlling a servomotor of the clamping device of claim 20 depending on a rotation speed of a drive motor of the machine tool,
wherein
the rotation speed of the servomotor (11) is adjusted by means of a control unit (70) for increasing or reducing the clamping force of the power-operated chuck (5) during a machining process, such that the servomotor (11) rotates synchronously with the rotation speed of a drive motor (4) for coupling a drive gear (16) with a sliding sleeve (51), and the servomotor (11) is driven with increased or reduced speed in relation to the synchronous speed in order to increase or reduce the clamping force.
